(19) United States
(12) Patent Application Publication
(10) Pub. No.: US 2014/0202293 A1
(43) Pub. Date: Jul. 24, 2014

(54) DAMPENING ADAPTER FOR MOUNTING A CUTTING TOOL ONTO A TURRET AND A METHOD OF USE

(71) Applicant: A TO Z MACHINE COMPANY, INC., Appleton, WI (US)

(72) Inventors: Gerald Richard Van Handel, Waupaca, WI (US); David Robert Zietlow, Almond, WI (US)

(73) Assignee: A TO Z MACHINE COMPANY, INC., Appleton, WI (US)

(21) Appl. No.: 13/744,525

(22) Filed: Jan. 18, 2013

(51) Int. Cl. B23Q 11/00; B23B 27/00

(52) U.S. Cl. CPC B23Q 11/0032; B23B 27/002
USPC 82/1.11; 29/39

(57) ABSTRACT

A dampening adapter is disclosed for mounting a cutting tool onto a machine turret to reduce vibration and flexing when the cutting tool engages a work piece, and a method of using the dampening adapter.

### FIELD OF THE INVENTION

This invention relates to a dampening adapter for mounting a cutting tool onto a machine turret to reduce vibration when the cutting tool engages a work piece, and a method of using the dampening adapter.

### BACKGROUND OF THE INVENTION

From time to time, machine shops with various types of manual and/or numerically controlled cutting machines, such as lathes, boring machines, grinding machines, milling cutters, drills, eta are asked to machine a work piece having a surface which is hard to reach or a hole which is relatively deep. This difficulty may be created by a work piece having an elongated length that needs a deep bore machined therein, or because the tool holder in the machine has an external diameter that is too large, or because the support arm for the tool is too short.

In these situations, a tool extender is required which can position the cutting tool away from the machine turret and adjacent to a surface of the work piece or into a bore formed in the work piece. The extender is usually secured to the machine turret in a cantilever fashion. A cutting tool, having a carbide, diamond or some other hardened tip, is securely mounted to the free end of the cantilevered extender and therefore projects well beyond the fulcrum point. As the cutting tool engages a work piece, vibrations and/or flexing forces are created which are transmitted back through the extender into the machine turret. If these vibrations or flexing forces become too large, the cutting tip or cutting tool can break or damage can occur to some other part of the machine. The amplitude, oscillation, frequency and/or harmonics of such vibrations and flexing can increase due to a number of factors. For example, the vibrations usually become more pronounced as the distance the extender extends away from the machine turret increases. Other causes of more severe vibration and flexing can occur when the depth of the cut into the work piece is increased, when the rotational speed of the work piece increases, when the cutting tool becomes dull, etc.

To remedy this problem, those skilled in the art have tried using various dampening extenders or adapters which include one or more movable springs and/or pistons positioned in an axial bore formed in such extenders or adapters. These mechanisms have failed to satisfactorily solve the problem. Others have tried using a movable slide positioned between the work piece and the machine turret to decrease the overhang and provide extra support to the extender. These slides do work but are relatively expensive due to their complexity and also require additional time for the machine operator to setup and remove. Still others have tried using an extender that is very long, over 6 feet in length, which extends outward in the opposite direction of the machine turret. The belief is that the opposite end of the extender will compensate for the cantilever portion which supports the cutting tool. However, the use of such a long extender prevents the machine turret from indexing so that another tool, secured thereto, cannot be used when the lengthy extender is mounted to the machine turret. This prevents a finishing tool from completing a precision cut on the work piece until the extender is removed.

Now, a dampening adapter and its method of use have been invented which reduces vibrations and flexing when a cutting tool, mounted thereon, engages a work piece. The new dampening adapter utilizes a large internal 1 so cavity which is filled with a moving pressurized fluid. The quantity and weight of the pressurized fluid, as well as the movement of the pressurized fluid through the cavity, from the machine turret end to the cutting tool end function to dampen vibration and flex forces that are created as the cutting tool engages a work piece.

### SUMMARY OF THE INVENTION

Briefly, this invention relates to a dampening adapter for mounting a cutting tool onto a machine turret. The dampening adapter includes an elongated housing having a closed first end, a closed second end, and a cavity extending between the first and second ends. The dampening adapter also includes a first attachment mechanism, secured adjacent to the first end, for mounting the dampening adapter onto the machine turret, and a second attachment mechanism, formed in the first end, for mounting the cutting tool. The dampening adapter further includes an inlet port formed through the housing, adjacent to the first end, and an outlet port formed through the second end. Pressurized fluid introduced to the inlet port can be routed through the cavity and be discharged from the outlet port. The pressurized fluid in the cavity facilitates dampening vibrations which can occur as the cutting tool engages a work piece.

A method of using the dampening adapter in a machine having a rotatable chuck and a machine turret is also disclosed. The dampening adapter includes an elongated housing having a closed first end, a closed second end, and a cavity extending between the first and second ends. The dampening adapter also includes a first attachment mechanism secured adjacent to the first end and a second attachment mechanism formed in the first end. The dampening adapter further includes an inlet port formed through the housing, adjacent to the first end, and an outlet port formed through the second end. The method includes the steps of securing a work piece in the rotatable chuck; securing the first attachment mechanism to the machine turret and aligning a pressurized fluid line with the inlet port; securing a cutting tool onto the second attachment mechanism; introducing pressurized fluid to the inlet port which is routed through the cavity and is discharged from the outlet port; positioning the cutting tool to engage the work piece; and engaging the work piece with the cutting tool whereby vibrations which occur can be dampened by the pressurized fluid present in the cavity of the dampening adapter.

The general object of this invention is to provide a dampening adapter for mounting a cutting tool onto a machine turret to reduce vibration and flexing when the cutting tool engages a work piece. A more specific object of this invention is to provide a dampening adapter having an elongated housing with a cavity formed therein which can be filled with a pressurized fluid and the pressurized fluid will reduce vibrations and flexing when the cutting tool engages a work piece.

Another object of this invention is to provide a dampening adapter having an elongated housing with a cavity formed therein which creates a fluid reservoir when a pressurized fluid is introduced into the cavity to thereby increase the weight of the dampening adapter, and reduce vibrations and flexing when the cutting tool engages a work piece.

A further object of this invention is to provide a dampening adapter having a cavity which is void of any moving parts or components.

Still another object of this invention is to provide a method of using the dampening adapter.

Still further, an object of this invention is to provide a method of removing the dampening adapter from a work piece and draining the pressurized fluid from the cavity.

Other objects and advantages of the present invention will become more apparent to those skilled in the art in view of the following description and the accompanying drawings.

### BRIEF DESCRIPTION OF THE DRAWINGS

FIG. 1 is a side view of a machine, such as a lathe, having a work piece secured to a rotatable chuck on the left and a dampening adapter mounted to a rotatable turret on the right.

FIG. 2 is a top view of the dampening adapter.

FIG. 3 is a left end view of the dampening adapter shown in FIG. 2.

FIG. 4 is a right end view of the dampening adapter shown in FIG. 2.

FIG. 5 is a side view of the dampening adapter shown in FIG. 2.

FIG. 6 is a left end view of the dampening adapter shown in FIG. 5.

FIG. 7 is a right end view of the dampening adapter shown in FIG. 5.

FIG. 8 is a vertical cross-sectional view of the dampening adapter shown in FIG. 5 taken along line 8-8.

FIG. 9 is a side view of the opposite side of the dampening adapter shown in FIG. 2 including depicting the heads of six machine bolts.

FIG. 10 is a front view of a machine bolt.

FIG. 11 is a top view of the machine bolt shown in FIG. 10 taken along line 11-11

FIG. 12 is a cross-sectional view of a spray nozzle.

FIG. 13 is a front view of an eye.

### DETAILED DESCRIPTION

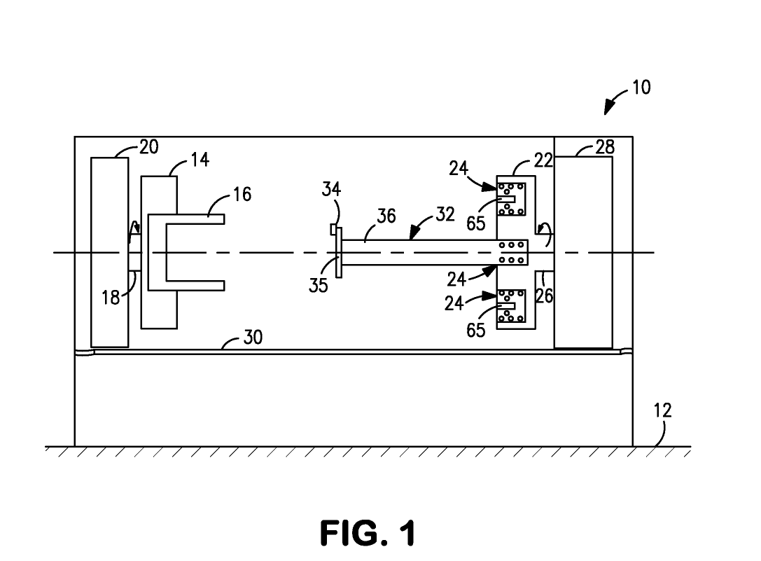

Referring to FIG. 1, a machine 10 is shown mounted to a concrete floor 12. The machine 10 can be any type of manual, automatic or computer controlled machine, such as a computer numerical control (CNC) machine. Furthermore, the machine 10 can be a numerically controlled lathe. Doosan Infracore, headquartered in Korea, sells a computer controlled lathe machine, model Doosan Puma 700. Those skilled in the art are aware of various machine manufactures that sell various types of cutting machines. By lathe it is meant a machine for shaping a piece of material, such as wood or metal, by rotating it rapidly along its axis while pressing against a fixed cutting or abrading tool. Alternatively, the machine 10 can be a boring machine, a grinder, a drill, a milling machine, or any other cutting machine known to those skilled in the machining arts. The machine 10 includes a chuck 14 which is capable of securely holding a work piece 16. By “chuck” it is meant a clamp that holds a tool or the material being worked on in a machine, such as a lathe. The chuck 14 is mounted on a rotatable shaft 18 which is driven by a motor 20. A transmission assembly (not shown) can be utilized to transmit power from the motor 20 to the rotatable shaft 18. The motor 20 and/or the transmission assembly can be configured to rotate the shaft 18 in either a clockwise and/or counter clockwise direction. A clockwise rotation is desirable.

The work piece 16 can be constructed from any known material and can have an infinite variety of shapes. The dimensions of the work piece 16 can also vary. The material from which the work piece 16 is made can be wood, a metal, ferrous metal, a non-ferrous metal, iron, steel, stainless steel, aluminum, nickel, magnesium, titanium, etc. The material can also be an alloy or be a composite material. Those skilled in the machining arts are aware of the different kinds of materials from which a work piece 16 can be made. By “wood′ it is meant the secondary xylem of trees and shrubs, lying beneath the bark and consisting largely of cellulose and lignin. By “metal” it is meant any of a category of electropositive elements that usually have a shiny surface, are generally good conductors of heat and electricity, and can be melted or fused, hammered into thin sheets, or drawn into wires; an alloy of two or more metallic elements. By “ferrous metal” it is meant of or relating to, or containing iron, especially with valence 2 or a valence lower than a corresponding ferric compound. By non-ferrous meter” it is meant not composed of or containing iron. By “iron” it is meant a lustrous, malleable, ductile, magnetic or magnetizable metallic element occurring abundantly in ores such as hematite and magnetite and used alloyed in a wide range of important structural materials. By steel it is meant a generally hard, strong durable malleable alloy of iron and carbon, usually containing between 0.2 and 1.5 percent carbon, often with other constituents such as manganese, chromium, nickel, or silicon, depending on the desired alloy properties, and widely used as a structural material. By “stainless steel” it is meant any of various steels that are alloyed with at least 10 percent chromium and sometimes containing other elements which are resistant to corrosion and rusting. By “aluminum’ it is meant a silvery-white, ductile metallic element, found chiefly in bauxite. By “nickel” it is meant a silvery hard ductile ferro-magnetic metallic element used in alloys and in corrosion-resistant surfaces and batteries and for electroplating. By “magnesium” it is meant a light metallic element that burns with a brilliant white flame and is used in structural alloys. By “titanium it is meant a strong, low density, highly corrosion-resistant metallic element that occurs widely in igneous rocks and is used to alloy aircraft metals for low weight, strength, and high-temperature stability. By “alloy” it is meant a homogeneous mixture or solid solution of two or more metals, the atoms of one replacing or occupying interstitial positions between the atoms of the other. By “composite” it is meant made up of distinct components; compounds.

Still referring to FIG. 1, the machine 10 also includes a turret 22. By “turret” it is meant an attachment for a lathe consisting of a cylindrical block capable of holding cutting tools. In a numerically controlled lathe, the turret 22 has multiple attachments surfaces 24 equally spaced around its outer periphery upon which a unique cutting tool can be mounted. Typically, ten or twelve attachment surfaces 24 are present. For example, with twelve attachment surfaces 24, each attachment surface 24 is spaced 30 degrees from an adjacent attachment surface 24. The size and dimensions of the turret 22 can vary. As the machine 10 increases in size, so will the turret 22. The turret 22 can be rotated or indexed a certain number of degrees so that each tool can sequentially perform an operation on the work piece 16. It is common to mount several cutting tools on the turret 22 at one time so that various shaped cutters and/or drills can be sequentially brought into engagement with the work piece 16. Typically, a rough cut is first made to the work piece 16. This can be followed by a finishing cut made by another tool. In addition, tools capable of performing various functions, such as forming counter bores, countersinks, drilling holes, etc. can also be mounted on the turret 22 and sequentially be brought into engagement with the work piece 16.

The turret 22 is mounted on a shaft 26, which in turn is connected to a drive assembly 28. Normally, the turret 22 is stationary during a machining operation. After a particular tool has performed its intended function, the turret 22 is indexed or incrementally rotated a predetermined number of degrees so that another tool can engage the work piece 16. The drive assembly 28 is movably mounted on one or more guide rails 30. A pair of spaced apart guide rails 30, 30, aligned parallel to one another, can be utilized. Only one guide rail 30 is depicted in FIG. 1. The drive assembly 28, with its attached turret 22, can be axially moved along the guide rails 30, 30 relative to the chuck 12 and the work piece 14. The drive assembly 28 can be locked in position anywhere along the guide rails, 30, 30 so that it cannot move.

In FIG. 1, a dampening adapter 32 is shown mounted to one of the multiple attachment points 24 on the turret 22. The dampening adapter 32 supports a cutting tool 34 on its free or distal end. The cutting tool 34 can be secured to a supporting arm 35. The cutting tool 34 can be one of a variety of special tools, including but not limited to a shank tool, a boring bar, a cartridge for holding multi-cutting edge tools, etc. The cutting tool 34 could also be a Capto® cutting unit which is available from AB Sandvik Coromant having an office at SE-811 81 Sandviken, Sweden. The cutting tool 34 normally includes an insert. Ceramics and cubic boron nitride inserts are used for machining of cast iron, heat resistant super alloys and hardened materials while polycrystalline diamond inserts are used for machining non-ferrous materials. Various other kinds and types of cutting tools 34 can also be utilized. AB Sandvik Coromant sells a variety of cutting tools 34. Another supplier of cutting tools 34 is Engman-Taylor Company, Inc. having an office at 3311 East Capitol Drive, Appleton, Wis. 54912.

The dampening adapter 32 functions to reduce, limit or eliminate vibrations and/or flexing when the cutting tool 34 engages a work piece 16. By “vibration” it is meant the act of vibrating; the condition of being vibrated; a rapid linear motion of a particle or of an elastic solid about an equilibrium position. By “flexing” it is meant to bend repeatedly. During vibrations, a harmonic motion can occur at a certain frequency or oscillation. By “harmonic” it is meant a wave whose frequency is a whole-number multiple of that of another. By “harmonic motion” it is meant a vibration in which the motions are symmetrical about a region of equilibrium. By “frequency” it is meant the property or condition of occurring at frequent intervals; the number of times a specified phenomenon occurs within a specified interval, as the number of repetitions of a complete sequence of values of a periodic function per unit variation of an independent variable or the number of complete cycles of a periodic process occurring per unit time. By “oscillate” it is meant to swing back and forth with a steady uninterrupted rhythm. By “oscillation” it is meant the act or state of oscillating; a single oscillatory cycle.

By reducing, limiting or eliminating such vibrations, one can produce a truer cut, extend the life of the cutting insert and prevent damage to the cutting tool 34 as well as to various parts of the machine 10. One may also be able to increase the depth of the cut, to operate the machine 10 at a higher speed, and to increase the overall efficiency of the cutting process.

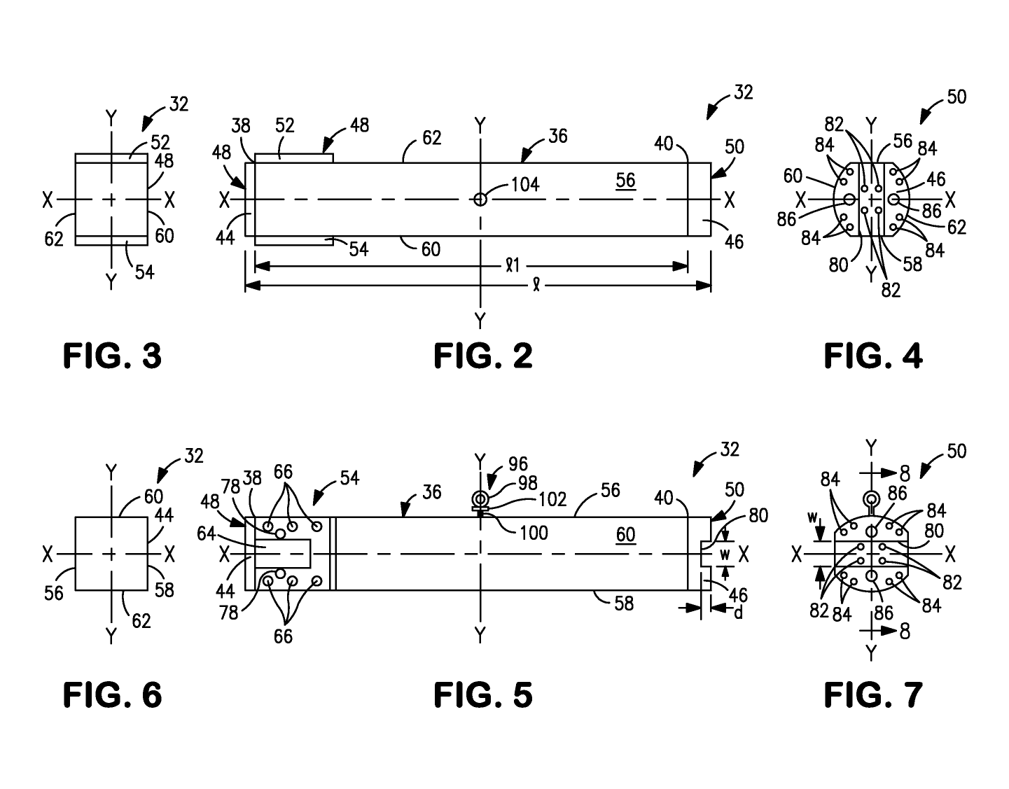

Referring to FIGS. 2-4, the dampening adapter 32 has a longitudinal central axis X-X and a vertical central axis Y-Y. The dampening adapter 32 can vary in size and shape. When designed to be used on a small lathe, the dampening adapter 32 can have an overall length l of from between about 6 inches to about 12 inches and have a diameter or a maximum cross-sectional dimension of from between about 1 inch to about 3 inches. For larger size machines 10, the dampening adapter 32 can have an overall length l of greater than about 12 inches. Desirably, the dampening adapter 32 has an overall length l of from between about 12 to about 48 inches. More desirably, the dampening adapter 32 has an overall length l of from between about 24 inches to about 42 inches. Even more desirably, the dampening adapter 32 has an overall length l of from between about 30 inches to about 36 inches. The diameter or the maximum cross-sectional dimension of the dampening adapter 32 can also increase in size as the overall length l of the dampening adapter 32 increases. For example, the diameter or the maximum cross-sectional dimension of the dampening adapter 32 having an overall length l of from between about 24 inches to about 36 inches can range from between about 4 inches to about 6 inches. The diameter or the maximum cross-sectional dimension of the dampening adapter 32 can be greater than about 6 inches when the overall length l of the dampening adapter 32 exceeds 36 inches.

The dampening adapter 32 can be formed or constructed from any durable material. Typically, the dampening adapter 32 is constructed from metal, iron, steel, stainless steel, a hardened steel, a metal alloy, etc. similar to any other kind of machine tool, boring bar, extenders, etc.

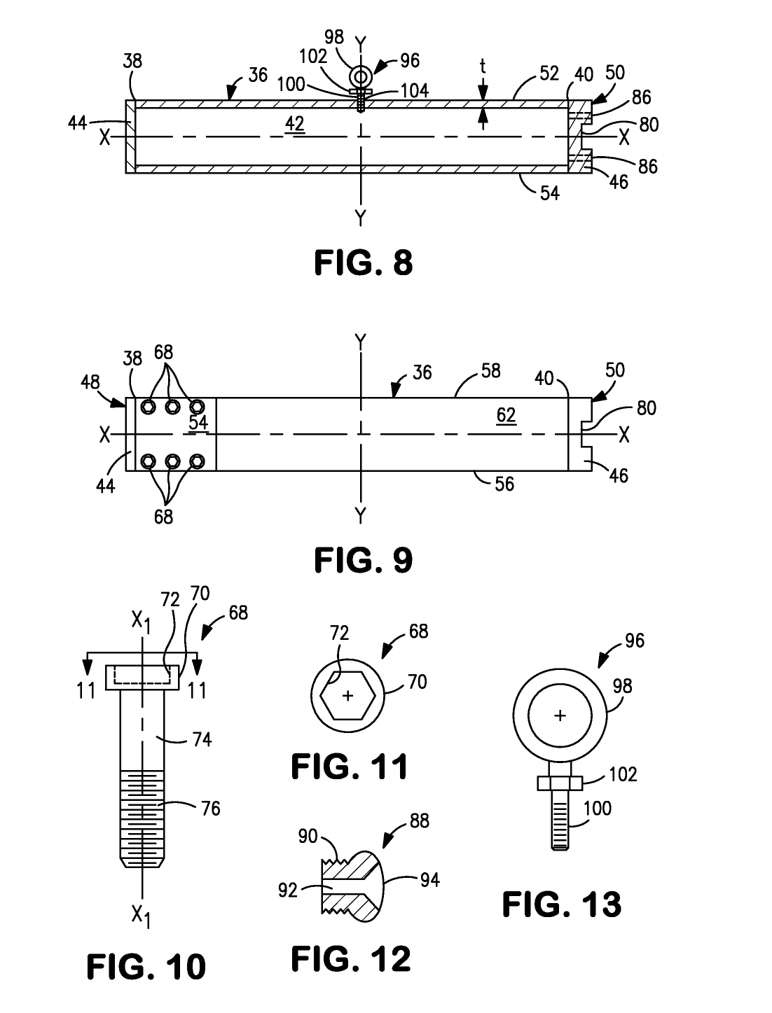

Referring now to FIG. 8, the dampening adapter 32 includes an elongated housing 36 having a length l₁ and a wall thickness t. The length l₁ of the elongated housing 36 can vary. The wall thickness t can also vary depending upon the size of the dampening adapter 32 and the material from which the dampening adapter 32 is constructed. Desirably, the wall thickness t will remain constant over the length h of the elongated housing 36. Alternatively, the wall thickness t could vary over the length l₁ of the elongated housing 36. The wall thickness t can range from between about 0.1 inches to about 2 inches. Desirably, the wall thickness t ranges from between about 0.20 inches to about 1 inch. More desirably, the wall thickness t ranges from between about 0.25 inches to about 0.75 inches. Even more desirably, the wall thickness t is less than about 0.5 inches.

It should be noted that the outside diameter or the maximum cross-sectional dimension of the elongated housing 36 should be equal to or less than about 30% of its length l₁. Desirably, the outside diameter or the maximum cross-sectional dimension of the elongated housing 36 is equal to or less than about 25% of its length l₁. More desirably, the outside diameter or the maximum cross-sectional dimension of the elongated housing 36 is equal to or less than about 20% of its length l₁. Furthermore, when the elongated housing 36 is a tubular member, its outside diameter should be equal to or be less than about 25% of its length 25%. When the elongated housing 36 is a four sided member having a square cross-section, each of the four sides should have a dimension which is less than about 25% of the length l₁.

Referring now to FIGS. 2-8, the elongated housing 36 has a first end 38, a second end 40 and a cavity 42, see FIG. 8. The cavity 42 extends between the first and second ends, 38 and 40 respectively. The elongated housing 36 encloses a predetermined area. The length l₁ of the elongated housing 36 is essentially equal to or slightly less than the overall length l of the dampening adapter 32. The reason for this will be explained shortly. The elongated housing 36 can also vary in geometrical shape and/or configuration. Furthermore, the cross-section of the elongated housing 36 can be constant or can vary over the length l of the elongated housing 36. The cross-section of the elongated housing 36 can be round or circular, square, rectangular, triangular, oval, a polygon, a pentagon, a hexagon, etc. The elongated housing 36 can be formed in a variety of ways. The elongated housing 36 can be formed from tubular stock, be a solid member with a bored cavity, or be assembled from two or more members which are secured together, such as by welding, to form a hollow elongated housing 36. A first plate 44 is secured, such as by a weld, to cover and close the first end 38. Likewise, a second plate 46 is secured, such as by a weld, to cover and close the second end 40. One will notice that the first plate 44 is relatively flat while the second plate 46 has been machined. Alternatively, the first and second plates, 44 and 46 respectively, can be replaced by plugs each having an outer surface which is aligned approximately flush with the first and second ends, 38 and 40 respectively, of the elongated housing 36.

The first and second plates, 44 and 46 respectively, can be secured in place by welding or be secured by one or more mechanical connectors, such as by machine screws. When the first and second plates, 44 and 46 respectively, are secured to the first and second ends, 38 and 40 respectively, of the elongated housing 36, the overall length l of the dampening adapter 32 will be slightly longer than the length l₁ of the elongated housing 36. If the first and is second plugs are inserted into the first and second ends, 38 and 40 respectively, of the elongated housing 36, then the overall length l of the dampening adapter 32 will equal the length l of the elongated housing 36.

Referring again to FIG. 8, the cavity 42 can vary in size, shape and volume. The cavity 42 should occupy from between about 50% to about 97% of the area created by the elongated housing 36. Desirably, the cavity 42 will occupy from between about 70% to about 95% of the area created by the elongated housing 36. More desirably, the cavity 42 will occupy at least about 75% of the area created by the elongated housing 36. Even more desirably, the cavity 42 will occupy at least about 80% of the area created by the elongated housing 36. In addition to the area of the cavity 42, the cavity 42 should extend over at least about 75% of the length l of the elongated housing 36. Desirably, the cavity 42 extends over at least about 80% of the length l₁ of the elongated housing 36. More desirably, the cavity 42 extends over at least about 85% of the length l₁ of the elongated housing 36. Even more desirably, the cavity 42 extends over at least about 90% of the length l₁ of the elongated housing 36.

The volume of the cavity 42 can vary depending on the size of the dampening adapter 32. For a dampening adapter 32 having an overall length l equal to or greater than about 24 inches and a diameter or maximum cross-sectional dimension equal to or greater than about 6 inches, the volume of the cavity 42 should be at least about 4 liters. Desirably, for a dampening adapter 32 having an overall length l equal to or greater than about 24 inches and a diameter or maximum cross-sectional dimension equal to or greater than about 6 inches, the volume of the cavity 42 should be at least about 8 liters, More desirably, for a dampening adapter 32 having an overall length l equal to or greater than about 24 inches and a diameter or maximum cross-sectional dimension equal to or greater than about 6 inches, the volume of the cavity 42 should be at least about 10 liters. Even more desirably, for a dampening adapter 32 having an overall length l equal to or greater than about 24 inches and a diameter or maximum cross-sectional dimension equal to or greater than about 6 inches, the volume of the cavity 42 should be at least about 12 liters.

It should be understood that if the dampening adapter 32 is less than about 12 inches in length, then the cavity 42 will be smaller and the volume of the cavity 42 should be equal to or greater than about 1 liter.

It is very important to understand that the cavity 42 is free or void of any moving parts or components. By component it is meant a constituent element, as of a system; a part of a mechanical or electrical complex. No pistons, piston rods, springs, seals or any other moving parts are positioned in or engage with the cavity 42. The only thing that occupies and moves through the cavity 42 is a pressurized fluid and/or air.

Referring again to FIGS. 2-7, the dampening adapter 32 also includes a first attachment mechanism 48 secured adjacent to the first end 38 for mounting the dampening adapter 32 onto the machine turret 22, and a second attachment mechanism 50 secured to the second end 40 for mounting the cutting tool 34. The first attachment mechanism 48 can vary in shape and design. As depicted, the first attachment mechanism 48 includes a pair of support members 52 and 54. The pair of support members 52 and 54 is aligned opposite to one another and each is secured to the outer surface of the elongated housing 36, such as by a weld. If the elongated housing 36 has a circular outer periphery, the pair of support members 52 and 54 can be arcuate in shape. If the elongated housing 36 has a square outer periphery or has a geometrical shape with flat sides, the pair of support members 52 and 54 can be flat in shape. The elongated housing 36, shown in FIGS. 2-7, has a square cross-section with a top surface 56, a bottom surface 58, and a pair of side surfaces 60 and 62. The first end 38 of the elongated housing 36 has a rectangular configuration by the addition of the pair of support members 52 and 54.

Referring to FIGS. 1 and 5, the dampening adapter 32 is shown and the support member 54 is depicted as having a raise plateau 64, see FIG. 5. The plateau 64 can vary in size, shape, height and location on the support member 54. In FIG. 5, the plateau 64 is depicted as having a rectangular shape. The plateau 64 extends upward above the remaining surface of the support member 54 and is designed to mate with a slot 65 formed in one of the attachment surfaces 24 on the machine turret 22, see FIG. 1. The cooperation between the plateau 64 and the slot 65, formed in each of the attachment surfaces 24, will prevent the dampening adapter 32 from rotating or twisting once it is secured to the turret 22. The plateau 64 extends upward above the remaining surface of the support member 54 by a distance of from between about 0.15 inches to about 0.5 inches. Desirably, the plateau 64 extends upward above the remaining surface of the support member 54 by a distance equal to or greater than about 0.25 inches. The slot 65 extends into each of the attachment surfaces 24, 24 by a distance of from between about 0.15 inches to about 0.5 inches. Desirably, each slot 65 extends inward below the remaining portion of each of the attachment surfaces 24, 24 by a distance equal to or greater than about 0.25 inches.

Referring to FIGS. 5, and 9-11, in addition to the raised plateau 64, the support member 54 also contains a plurality of apertures 66 formed therethrough. The number, size and shape of the apertures 66 can vary. Six apertures 66 are depicted in FIG. 5, with three being located on each side of the raised plateau 64. Each aperture 66 is sized and designed to receive a threaded machine bolt 68, see FIG. 9. The other support member 52 also contains a similar number of apertures 66 as the support member 54. The apertures 66 formed in the support members 52 and 54 are aligned with one another. A like number of apertures 66, not shown, of equal size and shape, are also formed through the elongated housing 36 and are aligned with the apertures 66 in the support members 52 and 54. A machine bolt 68 is positioned in and extends through each of the apertures 66 formed through the support member 52, the elongated housing 36 and the other support member 54.

Referring to FIGS. 10 and 11, one of the machine bolts 68 is shown having a longitudinal central axis X₁-X₁ with an enlarged head 70 containing a hexagonal recess 72 formed therein. The hexagonal recess 72 is designed to receive a hexagonal shape tool so that the machine bolt 68 can be tightened or loosened. The machine bolt 68 also has a shank 74 extending downward from the enlarged head 70. At least a portion of the shank 74 contains threads 76. The size, shape and pitch of the threads 76 can vary. Standard washers and/or lock washers, not shown, can also be used with each machine bolt 68, as is well known to those skilled in the art. The threaded portion 76 of each shank 74 is designed to be threaded into one of the attachment surfaces 24 formed on the machine turret 22. The machine bolts 68 will hold and rigidly secure the dampening adapter 32 to the machine turret 22.

Referring again to FIG. 5, the dampening adapter 32 also has at least one inlet port 78 formed through the elongated housing 36 adjacent to the first end 38 of the elongated housing 36. The exact number of inlet ports 78, 78 utilized can vary as well as the size and shape of each inlet port 78. However, the number of inlet ports 78 should equal the number of fluid ports (not shown) which are formed in each of the attachment surfaces 24, 24 on the machine turret 22. Each of the fluid ports will be connected to fluid passages (not shown) passing through the turret 22 which, in turn, are connected to a fluid pump and reservoir. A control valve can be used to regulate the flow of pressurized fluid to the fluid ports.

In FIG. 5, a pair of inlet ports 78, 78 is depicted, each being located on an opposite side of the raised plateau 64. The pair of inlet ports 78, 78 is sized and aligned with a pair of fluid ports (not shown) formed in each of the attachment surfaces 24, 24 on the machine turret 22. The use of two inlet ports 78, 78 increases the amount of pressurized fluid that can be introduced into the cavity 42 once a control valve is opened that controls the flow of pressurized fluid from the pump and reservoir.

Referring now to FIGS. 4, 5, 7 and 9, one can clearly see that the second attachment mechanism 50 contains a deep slot 80. The slot 80 is located along a centerline of the second attachment mechanism 50. The slot 80 functions to receive and hold the supporting arm 35 to which the cutting tool 34 is secured. The slot 80 prevents the supporting arm 35 holding the cutting tool 34 from rotating. The size, shape and depth of the slot 80 can vary depending on the size of the dampening adapter 32. In FIG. 5, the slot 80 is shown having a width w which can range from between about 1 inch to about 3 inches. Desirably, the width w of the slot 80 is equal to or greater than about 1.5 inches. More desirably, the width w of the slot 80 is equal to or greater than about 2 inches. The slot also has a depth d measured along the X-X axis. The depth of the slot 80 can vary. The depth d of the slot 80 is equal to or greater than about 0.25 inches. Desirably, the depth d of the slot 80 is equal to or greater than about 0.375 inches. More desirably, the depth d of the slot 80 is equal to or greater than about 0.50 inches. Even more desirably, the depth d of the slot 80 is equal to or greater than about 0.60 inches.

The second attachment mechanism 50 of the dampening adapter 32 also includes one or more first threaded apertures 82 formed in the lower surface of the slot 80. Four of the first threaded apertures 82, 82, 82 and 82 are depicted in FIGS. 4 and 7. The first threaded apertures 82, 82, 82 and 82 are spaced apart from one another and are sized to receive machine screws (not shown) which can pass through the supporting arm 35 which holds the cutting tool 34. The machine screws secure the supporting arm 35 to the second attachment mechanism 50.

The second attachment mechanism 50 further includes one or more second threaded apertures 84. Eight of the second threaded apertures 84 are depicted in FIGS. 4 and 7. The eight second threaded apertures 84 are spaced apart from one another and are grouped in pairs. The second apertures 84 are sized to receive machine screws (not shown) for securing various types of cutting tools 34 onto the second attachment mechanism 50. The machine screws secure the cutting tool 34 to the second attachment mechanism 50.

Referring now to FIGS. 4, 7 and 8, the second attachment mechanism 50 also includes at least one outlet port 86. The number of outlet ports 86, 86 can vary. In FIGS. 4, 7 and 8 a pair of outlet ports 86, 86 is depicted. The pair of outlet ports 86, 86 communicate with the cavity 42 and provide openings for the discharge of the pressurized fluid from the cavity 42.

Referring to FIG. 12, a cross-section of a spray nozzle 88 is shown. The spray nozzle 88 contains a threaded portion 90, a fluid passage 92 and a configured outlet 94. The threaded portion 90 is sized to be threaded into one of the outlet ports 86, 86. If two outlet ports 86, 86 are present, then a spray nozzle 88 would be secured to each of them. Each spray nozzle 88 functions to control the direction and flow pattern of pressurized fluid from the pair of outlets 86, 86. The pressurized fluid discharged from the spray nozzles 88, 88 should be directed onto the cutting inserts of the cutting tool 34 so as to cool the cutting insert as material is being cut from the work piece 16.

Fluid is introduced to the inlet ports 78, 78 and is routed through the cavity 42 before being discharged from the outlet ports 86, 86. By fluid it is meant a continuous amorphous substance whose molecules move freely past one another and that assumes the shape of its container. Desirably, the fluid is pressurized before is passes through the inlet ports 78, 78. The fluid can be pressurized to any desired pressure value, normally expressed in pounds per square inch (psi). The fluid can have a pressure of from between about 50 psi to about 300 psi. Desirably, the fluid is at a pressure of from between about 80 psi to about 200 psi. More desirably, the fluid is pressurized from between about 100 psi to about 150 psi. Even more desirably, the fluid is at a pressure of at least about 120 psi. The pressurized fluid in the cavity 42 functions to dampen or eliminate vibrations and/or flexing which occur as the cutting tool 34 engages the work piece 16. The pressurized fluid can vary in composition. The pressurized fluid can be a liquid. By liquid it is meant a state of matter characterized by a readiness to flow, little or no tendency to disperse, and relatively high incompressibility. Furthermore, the pressurized fluid can be a semi-fluid. By semi-fluid it is meant intermediate in flow properties between solids and liquids: viscous.

The pressurized fluid can be a cutting fluid coolant used to cool the cutting insert of the cutting tool 34 during machining. Schaeffers Lubricants, having an office in St. Louis, Mo., sells a coolant, model number “HTC iso 68” which works well. Alternatively, the pressurized fluid could be water, an oil, a lubricating oil, a gel, a paste, a gelatin, a jellylike substance, a smooth viscous mixture, a wax, grease, a plastic solid, such as paraffin, a resinous mixture, a cream, a foam, etc. Desirably, the pressurized fluid is a liquid which has a viscosity greater than water. For example, the pressurized fluid can have a viscosity equal to or greater than 0.01 poise measured at a temperature of 25° C. More desirably, the pressurized fluid has a viscosity of at least 0.015 poise at 25° C. Even more desirably, the pressurized fluid has a viscosity of at least 0.02 poise at 25° C. By “viscosity” it is meant the condition or property of being viscous; a numerical measure of the degree to which a fluid resists flow under an applied force.

Viscosity is a measure of the resistance of a fluid which is being deformed by either shear stress or tensile stress. In everyday terms (and for fluids only), viscosity is “thickness” or “internal friction”. Thus, water is “thin”, having a lower viscosity, while honey is “thick”, having a higher viscosity. Put simply, the less viscous the fluid is, the greater its ease of movement (fluidity).

Viscosity describes a fluid's internal resistance to flow and may be thought of as a measure of fluid friction. For example, high-viscosity felsic magma will create a tall, steep stratovolcario, because it cannot flow far before it cools, while low-viscosity mafic lava will create a wide, shallow-sloped shield volcano.

With the exception of superfluids, all real fluids have some resistance to stress and therefore are viscous. A fluid which has no resistance to shear is known as an ideal fluid or inviscid fluid. In common usage, a liquid with the viscosity less than water is known as a mobile liquid, while a substance with a viscosity substantially greater than water is simply called a viscous liquid.

The dynamic viscosity of water is 8.90×10⁻⁴ Pa-s or 8.90×10⁻³ dyn-s/cm² or 0.890 cP at about 25° C. Water has a viscosity of 0.0091 poise at 25° C. or 1 centipoise at 20° C. By “poise” it is meant a centimeter-gram-second unit of dynamic viscosity equal to one dyne-second per square centimeter.

The pressurized fluid can be at room temperature or be below room temperature. By “room temperature” it is meant an indoor temperature of from 68° F. to 77° F. Desirably, the pressurized fluid is at a temperature below room temperature so that it serves as a coolant for the heat being generated by the cutting process. The temperature of the pressurized fluid can range from between about 35° F. to about 65° F. Desirably, the temperature of the pressurized fluid can range from between about 40° F. to 60° F. More desirably, temperature of the pressurized fluid is less than about 55° F.

The cavity 42 receives the pressurized fluid and fills to its maximum volume. By “volume” it is meant the amount of space occupied by a three-dimensional object or region of space, expressed in cubic units. The volume of the cavity 42 can vary depending upon the size of the dampening adapter 32. The volume of the cavity should be at least about 1 liter. By “liter” it is meant a metric unit of volume equal to approximately 1.056 liquid quarts or 0.264 gallon. By “gallon” it is meant a unit of volume in the U.S. Customary System, used in liquid measure. 1 gallon=4 quarts (3.785 liters). Desirably, the volume of the cavity 42 ranges from between about 2 liters to about 20 liters. More desirably, the volume of the cavity 42 ranges from between about 3 liters to about 15 liters. Even more desirably, the volume of the cavity 42 is at least about 4 liters.

It should be understood that the cavity 42 contains air before the pressurized fluid is introduced through the inlet ports 78, 78. Some air may remain in the cavity 42 when it is filled with the pressurized fluid.

The weight of the pressurized fluid can vary. When the pressurized fluid is a cutting fluid coolant, it can have a weight of from between about 2 to about 5 pounds per liter. The weight of the pressurized fluid, in combination with the weight of the dampening adapter 32, which can exceed 100 pounds, creates a heavy mass which is very effective in dampening any vibrations created as the cutting tool 34 engages the work piece 16. A dampening adapter 32, which has a length l of at least 24 inches, a diameter or cross-sectional dimension of about 6 inches, and a cavity which can handle a volume of about 12 liters, can weigh about 150 pounds or more. The motion of the pressurized fluid appears to add to the dampening effect. The moving pressurized fluid may be more advantageous than using a stationary pressurized fluid in the cavity 42.

Referring now to FIG. 13, a support mechanism 96 is shown. The support mechanism 96 can vary in size and configuration. In FIG. 13, the support mechanism 96 is depicted as an eye having a closed loop 98 with a threaded stem 100 extending outward therefrom. A nut 102 is rigidly fixed to the threaded stem 100 such that as one turns the nut 102, the loop 98 and the attached threaded stem 100 will rotate as a unit. The support mechanism 96 is an integral member. The support mechanism 96 can be formed from a variety of materials. Desirably, the support mechanism 96 is constructed from iron, metal, steel or an alloy thereof. The support mechanism 96 is sturdily constructed.

Referring again to FIG. 2, a threaded aperture 104 is formed in the elongated housing 36 approximately midway between the first and second ends, 38 and 40 respectively. Desirably, the threaded aperture 104 is formed in the elongated housing 36 such that the weight of the elongated housing 36 is evenly distributed on either side of the threaded aperture 104. If the dampening adapter 32 is heavier at one end, then the threaded aperture 104 should be located closer to that end so that the weight of the dampening adapter 32 is evenly distributed.

Referring again to FIGS. 5 and 8, the threaded stem 100 of the support mechanism 96 is shown secured in the threaded aperture 104. The support mechanism 96 functions to provide a structure such that a hook connected to a hydraulic or pneumatic lift, or to an overhead crane, can be removably attached to the dampening adapter 32. The lift or crane can then lift, lower, move and position the dampening adapter 32 into or out of the machine 10. Since the dampening adapter 32 is constructed of iron, metal or steel and can weigh over 100 pounds, it is rather heavy to be lifted and moved by one person.

### Method

A method of using the dampening adapter 32 in a machine 10 will now be explained. The machine 10 includes a rotatable chuck 14 and a turret 22. The dampening adapter 32 includes an elongated housing 36 having a first end 38, a second end 40, and a cavity 42 extending between the first and second ends, 38 and 40 respectively. The first and second ends, 38 and 40 respectively are closed by first and second plates, 44 and 46 respectively. The dampening adapter 32 also includes a first attachment mechanism 48 secured adjacent to the first end 38, and a second attachment mechanism 50 secured to the second end 40. The dampening adapter 32 further includes an inlet port 78 formed through the elongated housing 36 adjacent to the first end 38, and an outlet port 86 formed through the second end 40. The method includes the steps of securing a work piece 16 in the rotatable chuck 14. The first attachment mechanism 48 is then secured to the turret 22 such that the inlet port 78 is aligned with an incoming pressurized fluid line. The pressurized fluid line functions to direct fluid from a reservoir via a pump to the inlet port 78. The pump pressurizes the fluid to a predetermined psi value. A cutting tool 34 is secured onto the second attachment mechanism 50. Pressurized fluid is then introduced to the inlet port 78 which is routed through the cavity 42 before being discharged from the outlet port 86. The pressurized fluid will eventually fill the volume of the cavity 42. The cutting tool 34 is then positioned to engage the work piece 16. The cutting tool 34 can include a hardened cutting insert that actually contacts the work piece 16 and performs the cut. As the cutting tool 34 engages the work piece 16 and starts cutting, vibrations and/or flexing occur. These vibrations and flexing are dampened and/or eliminated by the pressurized fluid present in and moving through the cavity 42. The volume of the pressurized fluid, in combination with the movement of the pressurized fluid through the cavity 42, and the heavy weight of the dampening adapter 32, dampens out any harmonic motion created by the cutting action. By reducing and/or preventing vibrations and flexing, one can gain process efficiency while assuring that the machine 10 and its various components will not be damaged or destroyed. By minimizing vibrations and flexing, one can possibly run the machine at a higher rpm, make a deeper cut, increase the travel speed of the cutting tool 34, etc.

The method can also include the step of securing a spray nozzle 88 in the outlet port 86 for controlling both the direction and flow pattern of the pressurized fluid onto the cutting tool 34.

Another option is to form a threaded aperture 104 in the elongated housing 36, approximately midway between the first and second ends, 38 and 40 respectively, and then secure a support mechanism 96 into the threaded aperture 104. The attached support mechanism 96 provides an easy way to attach a hook from a hydraulic or pneumatic lift, or from an overhead crane, and facilitate moving the dampening adapter 32 into and out of the machine 10.

The method can further include the step of disengaging the cutting tool 34 from the work piece 16, stopping the flow of pressurized fluid to the inlet port 78, and allowing the pressurized fluid in the cavity 42 to drain out of the cavity 42 via the outlet port 86. With the cavity 42 empty, the dampening adapter 32 can then be unconnected from the machine turret 22 and be removed from the machine 10.

It should be recognized that the dampening adapter 32 is so constructed that the machine turret 22 can be rotatably indexed through a predetermined number of degrees without first requiring the removal of the dampening adapter 32. This is beneficial, for it allows the machine operator to index the machine turret 22 so that other cutting tools can sequentially engage the work piece 16. This speeds up the overall process and makes it economical to use the dampening adapter 32.

While the invention has been described in conjunction with a specific embodiment, it is to be understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A dampening adapter for mounting a cutting tool onto a turret, comprising:
a) an elongated housing having a closed first end, a closed second end, and a cavity extending between said first and second ends;
b) a first attachment mechanism secured adjacent to said first end for mounting said dampening adapter onto said turret;
c) a second attachment mechanism secured to said second end for mounting said cutting tool;
d) an inlet port formed through said housing adjacent to said first end; and
e) an outlet port formed through said second end, whereby pressurized fluid introduced to said inlet port can be routed through said cavity and be discharged from said outlet port, and said pressurized fluid in said cavity functions to dampen vibrations which occur as said cutting tool engages a work piece.

2. The dampening adapter of claim 1 wherein said elongated housing encloses an area said cavity occupies at least about 75% of said area, and said cavity is void of any moving components.

3. The dampening adapter of claim 1 wherein said elongated housing has a length of at least about 24 inches and said cavity extends over at least about 90% of said length.

4. The dampening adapter of claim 1 further comprising a threaded aperture formed in said housing approximately midway between said first and second ends, and a support mechanism is secured in said threaded aperture to facilitate moving said dampening adapter.

5. The dampening adapter of claim 4 wherein said support mechanism comprises a closed loop having an outwardly extending threaded stem.

6. The dampening adapter of claim 1 wherein said cavity has a volume of at least about 4 liters.

7. The dampening adapter of claim 1 further comprising securing a spray nozzle in said outlet port for controlling fluid direction and flow pattern.

8. The dampening adapter of claim 1 wherein said pressurized fluid is a viscous liquid having a viscosity greater than 0.01 poise at 25° C.

9. The dampening adapter of claim 1 wherein said pressurized fluid is a semi-fluid.

10. A dampening adapter for mounting a cutting tool onto a turret, comprising:
a) an elongated housing having a closed first end, a closed second end, and a cavity extending between said first and second ends;
b) a first attachment mechanism secured adjacent to said first end for mounting said dampening adapter onto said turret, said attachment mechanism including at least one indentation;
c) a second attachment mechanism secured to said second end for mounting said cutting tool;
d) an inlet port formed through said housing adjacent to said first end;
e) a spray nozzle secured in said outlet port for controlling fluid direction and flow pattern; and
f) an outlet port formed through said second end, whereby pressurized fluid introduced to said inlet port can be routed through said cavity and be discharged from said spray nozzle, said cavity having a volume of at least 1 liter, and said pressurized fluid in said cavity functions to dampen vibrations which occur as said cutting tool engages a work piece.

11. The dampening adapter of claim 10 wherein said housing is constructed from metal, has a length of at least about 24 inches, and has a wall thickness of at least about 0.25 inches.

12. The dampening adapter of claim 11 wherein said housing is a tubular member with an outside diameter less than about 25% of said length.

13. The dampening adapter of claim 11 wherein said housing is a four sided member having a square cross-section, and each of said four sides has a dimension which is less than about 25% of said length.

14. The dampening adapter of claim 10 wherein said pressurized fluid is introduced into said cavity at a temperature at or below room temperature, and at a pressure of at least about 120 psi.

15. The dampening adapter of claim 10 wherein said pressurized fluid is a cutting tool coolant having a viscosity greater than 0.015 poise at 25° C.

16. A method of using a dampening adapter in a machine having a rotatable chuck and a turret, said dampening adapter including an elongated housing having a closed first end, a closed second end, and a cavity extending between said first and second ends, a first attachment mechanism secured adjacent to said first end, a second attachment mechanism secured to said second end, an inlet port formed through said housing adjacent to said first end, and an outlet port formed through said second end, said method comprising the steps of:
a) securing a work piece in said rotatable chuck;
b) securing said first attachment mechanism to said turret and aligning a pressurized fluid line with said inlet port;
c) securing a cutting tool onto said second attachment mechanism;
d) introducing pressurized fluid to said inlet port which is routed through said cavity and is discharged from said outlet port;
e) positioning said cutting tool to engage said work piece; and
f) engaging said work piece with said cutting tool whereby vibrations which occur are dampened by said pressurized fluid present in and moving through said cavity.

17. The method of claim 16 further comprising securing a spray nozzle iii said outlet port for controlling fluid direction and flow pattern.

18. The method of claim 16 further comprising forming a threaded aperture in said housing approximately midway between said first and second ends, and securing a support mechanism in said threaded aperture to facilitate moving said dampening adapter.

19. The method of claim 16 further comprising disengaging said cutting tool from said work piece, stopping the flow of said pressurized fluid to said inlet port, and allowing said pressurized fluid in said cavity to drain out of said cavity via said outlet port.

20. The method of claim 16 wherein said turret can be rotatably indexed through a predetermined number of degrees without removing said dampening adapter.
